(19) United States
(12) Patent Application Publication
(10) Pub. No.: US 2026/0305862 A1
(43) Pub. Date: Oct. 8, 2026

(54) LIQUID HEATING APPLIANCES WITH LIQUID TEMPERATURE MONITORING

(71) Applicant: Strix Limited, Ronaldsway, Isle of Man (GB)

(72) Inventors: Raymond Doyle, Ronaldsway (GB); Marc Gibson Collinson, Ronaldsway (GB); Richard Brandon Fumagalli, Ronaldsway (GB); Colin Peter Moughton, Ronaldsway (GB)

(21) Appl. No.: 19/475,325

(22) PCT Filed: Apr. 11, 2024
(86) PCT No.: PCT/GB2024/050951

§ 371 Date: Oct. 14, 2025

(30) Foreign Application Priority Data
Apr. 13, 2023 (GB) 2305461.2
May 12, 2023 (CN) 202310540091.7

(51) Int. Cl. A47J 27/21

(52) U.S. Cl. CPC A47J 27/2105

(57) ABSTRACT

A liquid heating appliance for heating liquid to a boiling temperature, comprising: a liquid heating vessel; an electrical heater for heating liquid contained within the liquid heating vessel, and an electrical power supply circuit arranged to power the electrical heater; detection means arranged to detect when the liquid contained within the liquid heating vessel is approaching boiling point but has a liquid temperature below its boiling temperature that corresponds to an early cut-off temperature; and an electrical control unit comprising control circuitry arranged to interrupt the electrical power supply circuit, thereby deactivating the electrical heater, in response to the detection means detecting that the liquid temperature corresponds to the early cut-off temperature. The liquid heating vessel is configured such that residual heat of the electrical heater causes the liquid temperature to continue to rise to the boiling temperature after the electrical heater has been deactivated at the early cut-off temperature. A display assembly may be configured to indicate to a user of the appliance that the liquid temperature has reached the boiling temperature.

The present invention relates to a liquid heating appliance.

In liquid heating appliances, such as domestic kettles, an electrical heater is typically arranged to heat liquid stored within a liquid heating vessel of the appliance. Control units may be provided in order to control the provision of electrical power to the electrical heater, e.g. to initiate or terminate a heating operation. In cordless appliances, power is typically provided to the cordless liquid heating vessel via a power base connected to a mains supply of electricity.

Said control units often include a switch for removing the supply of electrical power from the appliance when a particular temperature or condition is sensed within the appliance, thereby switching off the electrical heater. For example, the control unit may be arranged to disconnect the power supply when the liquid inside the liquid heating vessel has reached boiling temperature. However, since the residual heat of the electrical heater will continue to heat the liquid even after the electrical heater is switched off, there is an overshoot if the electrical heater is switched off only in reaction to the liquid reaching the boiling temperature. This overshoot results in wasted energy, and hence results in unnecessary electricity costs over the lifespan of the appliance.

According to a first aspect of the invention, there is provided a liquid heating appliance for heating liquid to a boiling temperature, comprising:
a liquid heating vessel;
an electrical heater for heating liquid contained within the liquid heating vessel, and an electrical power supply circuit arranged to power the electrical heater;
detection means arranged to detect when the liquid contained within the liquid heating vessel is approaching boiling point but has a liquid temperature below its boiling temperature that corresponds to an early cut-off temperature; and
an electrical control unit comprising control circuitry arranged to interrupt the electrical power supply circuit, thereby deactivating the electrical heater, in response to the detection means detecting that the liquid temperature corresponds to the early cut-off temperature,
wherein the liquid heating vessel is configured such that residual heat of the electrical heater causes the liquid temperature to continue to rise to the boiling temperature after the electrical heater has been deactivated at the early cut-off temperature.

The applicant has appreciated that by detecting when the liquid in the heating vessel is approaching its boiling point, the electrical heater can be deactivated early, and yet, as a result of the residual heat of the electrical heater (e.g. the heating element), the temperature of the liquid will continue to rise. As such, by deactivating the electrical heater at a point which is prior to the liquid reaching boiling, but at which the liquid is at a sufficiently high temperature that it will still reach its boiling point, the liquid can still be boiled, but the amount of active heating is reduced. This can result in a significant energy saving over the life span of the appliance.

There are known various types of detection means which can be arranged to detect when the liquid contained within the liquid heating vessel is approaching boiling point, for example an acoustic sensor (e.g. monitoring the sound levels produced as the liquid approaches boiling point), an optical sensor (e.g. monitoring the changes in liquid level and turbulence as the liquid approaches boiling point), a steam sensor, or a liquid temperature sensor (e.g. monitoring the liquid temperature directly or indirectly). In some embodiments, the appliance comprises an electronic temperature sensor configured to provide liquid temperature data. In some embodiments, the electronic temperature sensor is a thermistor.

In some embodiments, the appliance comprises a processor and the electronic temperature sensor is configured to provide liquid temperature data to the processor.

In some embodiments, the appliance comprises a display assembly configured to indicate to a user of the appliance that the liquid temperature has reached the boiling temperature when the electronic temperature sensor detects that the liquid has reached boiling point due to the residual heat. The display assembly may receive the liquid temperature data directly from the electronic temperature sensor and display the liquid temperature data as received. Depending on the volume of liquid contained within the liquid heating vessel that is approaching boiling point, the liquid temperature data may accurately reflect the current liquid temperature However, in at least some circumstances (e.g. lower volumes of liquid), the appliance preferably uses a processor to assess when the liquid temperature has reached the boiling temperature based on the liquid temperature data provided by the electronic temperature sensor. Thus, in some embodiments, the processor that receives the liquid temperature data from the electronic temperature sensor is configured to control the display assembly based on the liquid temperature data. Preferably the display assembly is configured to indicate to a user of the appliance that the liquid temperature has reached the boiling temperature when it is determined by the processor, based on the liquid temperature data, that the liquid has reached the boiling temperature due to the residual heat remaining in the electrical heater after it has been deactivated. As is explained in further detail below, the liquid temperature data may lag behind the ‘true’ current liquid temperature but a suitable algorithm running on the processor can calculate the current liquid temperature before it is displayed.

The display assembly may indicate that boiling temperature has been reached by illuminating lights on a temperature scale or changing the colour of illumination. However, it is desirable for the boiling temperature to be displayed as a number so that a user feels confident that the boiling temperature has actually been detected. It is therefore preferable that the display assembly is configured to display a liquid temperature value (e.g. a current liquid temperature value) based on the liquid temperature data provided by the electronic temperature sensor. For example, the processor that receives the liquid temperature data from the electronic temperature sensor may be configured to convert the received liquid temperature data to a temperature value to be displayed. This is particularly relevant in the case of the present invention because the liquid heating appliance will sound different to a conventional liquid heating appliance. A conventional liquid heating appliance will not deactivate its heating element until after the liquid has boiled and so the liquid in the appliance will boil for a few seconds (e.g. typically less than 10 seconds). Users are accustomed to the sound which this period of boiling produces. Since the liquid heating appliance of the present invention deactivates the heating element at an early cut-off temperature, the liquid will more gently reach its boiling temperature and so the appliance will be quieter. As a result of not hearing what they are used to, the user may not initially have confidence that the liquid has boiled.

Preferably the display assembly comprises an alphanumeric display (such as a LCD or LED screen) and a processor for controlling the alphanumeric display. The same processor may be configured to obtain the liquid temperature data provided by the electronic temperature sensor (as mentioned above) and to control the alphanumeric display to display the current liquid temperature value. The display assembly may comprise a printed circuit board (PCB) and an alphanumeric display, e.g. mounted on the PCB. The display assembly may comprise a 7-segment alphanumeric display which may be controlled by a processor included on the PCB.

In some embodiments, the electrical control unit further comprises a trip lever for allowing a user to manually interrupt the electrical power supply circuit. The detection means may be configured to operate the trip lever upon detecting that the liquid contained within the liquid heating vessel has reached the early cut-off temperature. This provides a visual and/or audible indication to a user that the power supply has been cut-off early (i.e. saving energy) but the user can be assured by the display (as described above) that the liquid temperature continues to rise until boiling has been attained.

In some embodiments, the detection means comprises an electronic detection means arranged to detect that liquid within the liquid heating vessel has reached the early cut-off temperature and to operate a switch or the trip lever to interrupt the electrical power supply circuit upon said detection. The electronic detection means may comprise an electronic temperature sensor (e.g. a thermistor), for example arranged to measure (directly or indirectly) the temperature of liquid within the liquid heating vessel. This can be the same electronic temperature sensor as above or the electronic detection means may have its own dedicated electronic temperature sensor. The electronic temperature sensor may be mounted on the electrical control unit to contact the electrical heater (e.g. a heat diffuser plate thereof) or to extend into the liquid heating vessel (e.g. by passing through the heat diffuser plate to contact the liquid contained in the liquid heating vessel). In such embodiments, the appliance may further comprise a processor or control circuit and preferably the electronic temperature sensor is configured to provide a measurement signal representative of the temperature of liquid within the liquid heating vessel (e.g. liquid temperature data) to the processor or control circuit. The appliance may also comprise a relay or TRIAC configured to interrupt the electrical power supply circuit, for example connected to the processor or control circuit. The processor or control circuit may be included on the PCB of the display assembly discussed above. In such embodiments, if the appliance comprises a cordless liquid heating vessel seated on a power base stand, the processor or control circuit may be provided with the display assembly in the cordless liquid heating vessel. Alternatively, a discrete processor or control unit may be provided, for example at any suitable location in the appliance. In some embodiments, whether the appliance is cordless or not, the display assembly is housed in a side wall or handle of the liquid heating vessel.

In some embodiments, the liquid heating appliance is a cordless appliance. In some embodiments the electrical control unit comprises a control body defining a cordless electrical adapter part for mating with a corresponding base electrical connector part, e.g. of a corresponding power base stand, to receive a supply of electrical power. The control body may be a monolithic (e.g. moulded) plastics material body. The cordless electrical adapter part and corresponding base electrical connector part may be of the type that can be mated regardless of their relative angular orientation, or at least through a wide angular range (e.g. at least 340° and preferably up to 360°). Suitable cordless connectors of this “360° type” are described in WO95/08024 and WO01/28294, and are available as the Strix P72 or P76 connector parts.

In some embodiments, the liquid heating appliance is a cordless appliance comprising a power base stand, and the liquid heating vessel is arranged to be seated on the power base stand. The power base stand may comprise the corresponding base electrical connector part. This base electrical connector part may include tabs for electrical connection to a mains power supply cable, or the mains power supply cable may be integrated with the connector part. Preferably the base electrical connector part is mounted centrally on the power base stand.

In some embodiments, the power base stand may comprise the display assembly. This may help to isolate the display assembly from steam which is generated by the liquid heating vessel. In such embodiments, the processor or control circuit receiving the liquid temperature data (e.g. from the electronic temperature sensor) may be provided with the display assembly in the power base stand.

The cordless electrical adapter part located in the electrical control unit may comprise at least two mating conductors, for connecting to the live and neutral poles of the power supply circuit. An additional earth connection may also be present. In some embodiments, the cordless electrical adapter part is a 3-pole connector part (e.g. for mating with a Strix P72). In other embodiments, the cordless electrical adapter part is a 5-pole connector part (e.g. for mating with a Strix P76).

Such 5-pole connector parts provide for electronic signal connection as well as electrical power connection. Preferably the electrical power supply circuit of the liquid heating appliance is arranged to receive (e.g. from the base electrical connector part) an electrical current of between 3 and 15 amps.

At least in those embodiments wherein the power base stand comprises the display assembly, and optionally a/the processor configured to control the display assembly, the appliance may include a wireless (e.g. radio-frequency) or physical connection to communicate the liquid temperature data provided by the electronic temperature sensor to the components in the power base stand. Preferably the cordless electrical adapter part includes a physical electrical connection to communicate the liquid temperature data provided by the electronic temperature sensor to the power base stand. In some embodiments, the cordless electrical adapter part may comprise two or three terminals for supplying electrical power to the cordless liquid heating vessel and one or two further terminals for communicating the liquid temperature data to the base electrical connector part. For example, the cordless electrical adapter part may comprise five terminals (e.g. a 5-pole cordless connection as described in WO01/28294, the contents of which are hereby incorporated by reference).

In some other embodiments, the liquid heating appliance comprises an electrical power socket for receiving an electrical power cord for connecting to a mains electrical power supply. In some embodiments, the liquid heating appliance comprises an integrated power cord.

In various embodiments, the liquid heating appliance may comprise a heat diffuser plate arranged in thermal communication with the electrical heater. Preferably the electrical control unit is arranged to be mounted to an underside of the heat diffuser plate. In some embodiments, the electrical control unit comprises a mount plate for mounting the electrical control unit to the underside of the heat diffuser plate. The mount plate is preferably metal. The mount plate is preferably substantially flat.

In embodiments wherein an electronic temperature sensor is arranged to indirectly detect a temperature corresponding to the early cut-off temperature, the detected temperature may be the temperature of the electrical heater or the temperature of the heat diffuser plate. In embodiments wherein an electronic temperature sensor is arranged to directly detect a temperature corresponding to the early cut-off temperature, the electronic temperature sensor may protrude through the heat diffuser plate to contact the base of the liquid heating vessel or even protrude into the liquid heating vessel to be in contact with the liquid contained therein.

In some embodiments, the appliance comprises liquid volume estimation means configured to estimate a volume of the liquid contained within the liquid heating vessel.

In some embodiments, liquid volume estimation means may use the/an electronic temperature sensor to estimate the liquid volume based on the initial rate of temperature rise, e.g. as known from WO01/56436. As such, in embodiments, the liquid volume estimation means comprises a processor configured to: obtain liquid temperature data from a/the electronic temperature sensor whilst the liquid is being heated, use the liquid temperature data to measure the temperature gradient, and estimate the liquid volume based on the temperature gradient.

In some embodiments, in addition or alternatively, the liquid volume estimation means comprises one or more weight sensors (e.g. in the liquid heating vessel or elsewhere in the appliance e.g. in the power base stand of a cordless appliance) configured to measure the weight of the liquid contained within the liquid heating vessel. Using weight sensors to estimate the liquid volume may have the advantage that the liquid volume can be estimated before the liquid has begun to be heated. As such the liquid volume can be estimated more quickly. Further, the use of weight sensors may result in a more accurate estimated liquid volume.

In a sub-set of such embodiments, the display assembly is configured to display the estimated liquid volume based on the measured weight. For example, the estimated liquid volume is provided to the display assembly directly or indirectly (e.g. via a/the processor). The estimated liquid volume may be displayed in addition to the indication of boiling temperature (e.g. current temperature value), for example at the start and/or end of a boiling cycle, to give reliable and instant user feedback on the amount of water being boiled.

In some embodiments, the liquid heating appliance comprises a/the processor configured to set the early cut-off temperature based on the estimated liquid volume. The liquid volume is therefore taken into account when setting an appropriate value for the early cut-off temperature, as the amount of residual heat required to raise the liquid temperature to boiling temperature depends on the volume of liquid contained in the liquid heating vessel.

In some embodiments, the liquid heating appliance comprises a/the processor programmed with an anti-lag function which is dependent on liquid volume, and is configured to account for time lag between liquid temperature data (e.g. provided by an electronic temperature sensor) and the (e.g. actual) liquid temperature, wherein the processor is configured to estimate the current liquid temperature based on liquid temperature data, the anti-lag function, and the estimated liquid volume. The estimated liquid volume may be provided by any suitable type of liquid volume estimation means (e.g. using an electronic temperature sensor and/or one or more weight sensors).

The Applicant has recognised that the liquid temperature data, depending on how it is obtained, may not represent the actual liquid temperature within the liquid heating vessel and the anti-lag function can account for the time lag. For example, the time lag can be different for an electronic temperature sensor mounted in direct contact with liquid in the liquid heating vessel as compared to an electronic temperature sensor mounted in contact with the electrical heater. The extent of the time lag is can also be dependent on the liquid volume.

In some embodiments, the electronic temperature sensor may not be in direct contact with the liquid contained in the liquid heating vessel. For example, as mentioned above, the electronic temperature sensor may be mounted in contact with the heated base of the liquid heating vessel. This arrangement may be advantageous for simplifying construction of the liquid heating appliance, however, since the electronic temperature sensor is not able to directly measure the liquid temperature, this arrangement may lead to a time lag between changes in the measured liquid temperature data, and changes in the actual liquid temperature.

Since the relationship between the measured liquid temperature data and the actual temperature is dependent on the volume of liquid being heated, the anti-lag function can be developed (e.g. based on experimental data) having liquid volume as a variable. As such, if the volume of liquid in the liquid heating vessel is known, the anti-lag function can be used to compensate for the time lag, reducing the risk of overboil.

In some embodiments, the display assembly is configured to display the estimated current liquid temperature as the liquid temperature value. By using the anti-lag function, the displayed liquid temperature value can be relied upon as a true representation of the liquid temperature inside the liquid heating vessel.

While an electronic temperature sensor has been discussed above for providing liquid temperature data for the purposes of displaying an indication of boiling temperature and/or for estimating the liquid volume, it will be appreciated that an electronic temperature sensor is not necessary for detecting that the liquid temperature corresponds to the early cut-off temperature.

In some embodiments, the detection means comprises a thermomechanical actuator e.g. snap-action bimetallic element arranged to detect that some liquid within the liquid heating vessel has been converted into steam at the early cut-off temperature and to operate a switch or the trip lever to interrupt the electrical power supply circuit upon said detection. For example, the snap-action bimetallic element may be arranged to operate at a predetermined temperature of 70-80° C. Preferably the thermomechanical actuator is comprised in the electrical control unit.

In some embodiments, the detection means comprises a thermomechanical actuator as discussed above (preferably comprised in the electrical control unit) wherein the appliance comprises:
an outlet for allowing liquid to be poured from the liquid heating vessel;
a steam pipe configured to direct steam produced in the vessel to reach the thermomechanical actuator; and
a baffle configured to restrict steam from exiting the vessel via the outlet.

By providing the appliance with such a baffle, the thermomechanical actuator can detect the presence of steam in the vessel much earlier than in a standard kettle and hence detect that liquid in the liquid heating vessel has a liquid temperature below its boiling temperature that corresponds to the early cut-off temperature. This means that the thermomechanical actuator operates to interrupt the electrical power supply circuit when liquid in the vessel is at the early cut off temperature below its boiling temperature.

In some embodiments, the baffle comprises a partition extending below a minimum liquid fill line of the vessel. This prevents any steam which is produced on the opposite side of the partition from the outlet from escaping through the outlet. In these embodiments, substantially all of the steam produced in the vessel is forced into the steam pipe. This ensures that the thermomechanical actuator operates at the early cut off temperature.

In some embodiments, the appliance comprises a steam chamber housing the thermomechanical actuator. Preferably the steam chamber houses the electrical control unit when the electrical control unit and thermomechanical element are integrated. The steam chamber may be located at or close to the base of the vessel.

In some embodiments, the appliance comprises a steam guiding member (which is preferably provided on the electrical control unit) which is configured to guide steam away from the display assembly. In some embodiments, a display assembly housing is provided which at least partially surrounds the display assembly to restrict steam from reaching the display assembly.

In some other embodiments, the display assembly is housed in a side wall or handle of the vessel. This means that the display assembly can be positioned away from the electrical control unit in the steam chamber and is not exposed to steam.

In some embodiments, the electrical control unit comprises: a first set of electrical tabs connected to the electrical heater to form the electrical power supply circuit, wherein the control circuitry is arranged to interrupt the electrical power supply circuit, thereby deactivating the electrical heater, in response to the thermomechanical actuator detecting steam when the liquid temperature corresponds to the early cut-off temperature; and a second set of electrical tabs connected to the display assembly to form a bypass electrical power supply circuit. Since the display assembly is powered by this bypass electrical power supply circuit, it can indicate the liquid temperature to the user even after the main electrical power supply circuit to the heater has been interrupted. Furthermore, the bypass electrical power supply circuit can provide freedom for the display assembly to be positioned independently of the electrical control unit.

It is possible that the display assembly receives liquid temperature data from a remote temperature sensor, for example from an electronic temperature sensor positioned in or under the heated base of the vessel (e.g. integrated with the electrical control unit). For example, the electronic temperature sensor may be connected to the display assembly by a temperature signal wire or wireless connection may even be used. However, it is preferable for the display assembly to be co-located with the electronic temperature sensor. In some embodiments, the bypass electrical power supply circuit comprises the electronic temperature sensor and the display assembly is configured to indicate to a user of the appliance that the liquid temperature has reached the boiling temperature when the electronic temperature sensor detects that the liquid has reached the boiling temperature. The bypass electrical power supply circuit that provides for “overshoot” liquid temperature sensing and display is therefore independent of the electrical control unit that provides for disconnection of the electrical heater at the early cut off temperature.

In some embodiments, the bypass electrical power supply circuit further comprises a rechargeable power source for the display assembly. This means that the display assembly can continue to indicate the liquid temperature even if the appliance comprises a cordless liquid heating vessel that is lifted from its power base stand.

In some other embodiments, the appliance is a cordless appliance and the display assembly is housed in the power base stand. The display assembly can therefore remain powered regardless of whether the main electrical power supply circuit to the heater has been interrupted. Furthermore, no bypass electrical power supply circuit is required in the cordless liquid heating vessel. The display assembly may receive liquid temperature data from an electronic temperature sensor positioned in the cordless liquid heating vessel, for example from an electronic temperature sensor positioned in or under the heated base of the vessel (e.g. integrated with the electrical control unit). For example, the electronic temperature sensor may transmit the liquid temperature data through signal connections provided by the cordless electrical connector set to a processor located in the power base stand and configured to control the display assembly.

According to a second aspect of the invention, there is provided a method of heating liquid contained within a liquid heating vessel to a boiling temperature, comprising:
activating an electrical heater by completing an electrical power supply circuit to the electrical heater;
detecting when the liquid contained within the liquid heating vessel is approaching boiling point but has a liquid temperature below its boiling temperature that corresponds to an early cut-off temperature; and
interrupting the electrical power supply circuit, thereby deactivating the electrical heater, in response to detecting that the liquid temperature corresponds to the early cut-off temperature, such that residual heat of the electrical heater causes the liquid temperature to continue to rise to the boiling temperature after the electrical heater has been deactivated at the early cut-off temperature.

Preferably the method further comprises: determining that the liquid has reached the boiling temperature due to the residual heat and displaying to a user of the appliance that the liquid temperature has reached the boiling temperature.

In some embodiments, the method comprises obtaining liquid temperature data using an electronic temperature sensor. It may be determined that the liquid has reached the boiling temperature based on the obtained liquid temperature data. Preferably the method further comprises displaying to a user a liquid temperature value based on the obtained liquid temperature data.

In some embodiments, the method comprises measuring or estimating a volume of the liquid contained within the liquid heating vessel. The method may comprise setting the early cut-off temperature based on the measured or estimated volume.

In some embodiments, the method comprises:
obtaining liquid temperature data from an electronic temperature sensor whilst the liquid is being heated,
using the liquid temperature data to measure the temperature gradient, and estimating the
liquid volume based on the temperature gradient.

In some embodiments, the method further comprises using an anti-lag function which is dependent on liquid volume, and is configured to account for time lag between liquid temperature data and the (e.g. actual) liquid temperature, to estimate the current liquid temperature based on the liquid temperature data, the anti-lag function, and the measured or estimated liquid volume.

The Applicant has appreciated that such an anti-lag function can help to accurately estimate the current liquid temperature in any liquid heating appliance where the liquid temperature is being monitored, not only in appliances arranged to detect when the liquid is approaching boiling point.

According to a third aspect of the invention, there is provided a liquid heating appliance for heating liquid to a target temperature, comprising:
a liquid heating vessel;
an electrical heater for heating liquid contained within the liquid heating vessel, and an electrical power supply circuit arranged to power the electrical heater;
a processor;
an electronic temperature sensor configured to provide, to the processor, liquid temperature data for liquid contained within the liquid heating vessel; and
liquid volume estimation means configured to estimate a liquid volume contained within the liquid heating vessel,
wherein the processor is programmed with an anti-lag function, the anti-lag function being dependent on the liquid volume and configured to account for time lag between the liquid temperature data and the (e.g. actual) temperature of liquid contained within the liquid heating vessel, wherein the processor is configured to estimate a current liquid temperature based on the liquid temperature data, the anti-lag function, and the estimated liquid volume.

The Applicant has recognised that the liquid temperature data, depending on how it is obtained, may not represent the actual liquid temperature within the liquid heating vessel and the anti-lag function can account for the time lag. This can allow the target temperature to be detected more rapidly and/or accurately. For example, the time lag can be different for an electronic temperature sensor mounted in direct contact with liquid in the liquid heating vessel as compared to an electronic temperature sensor mounted in contact with the electrical heater. The extent of the time lag can also be dependent on the liquid volume.

In some embodiments, the electronic temperature sensor may not be in direct contact with the liquid contained in the liquid heating vessel. For example, as mentioned above, the electronic temperature sensor may be mounted in contact with the heated base of the liquid heating vessel. This arrangement may be advantageous for simplifying construction of the liquid heating appliance, however, since the electronic temperature sensor is not able to directly measure the liquid temperature, this arrangement may lead to a time lag between changes in the measured liquid temperature data, and changes in the actual liquid temperature.

Since the relationship between the measured liquid temperature data and the actual temperature is dependent on the volume of liquid being heated, the anti-lag function can be developed (e.g. based on experimental data) having liquid volume as a variable. As such, if the volume of liquid in the liquid heating vessel is known, the anti-lag function can be used to compensate for the time lag. In some embodiments, the anti-lag function may be an empirical model built from experimental data comparing the liquid temperature data to a measured (e.g. actual) temperature of liquid contained within the liquid heating vessel, for different liquid volumes.

In some embodiments, the target temperature is a temperature below the boiling temperature. In some embodiments, the target temperature is an early cut-off temperature. In some embodiments, the target temperature is the boiling temperature. In various embodiments, the target temperature may be pre-programmed and/or set by a user input.

In some embodiments, liquid volume estimation means may use the electronic temperature sensor to estimate the liquid volume based on the initial rate of temperature rise, e.g. as known from WO01/56436. As such, in embodiments, the liquid volume estimation means may comprise the processor (or another processor), and the processor is configured to: obtain liquid temperature data from the electronic temperature sensor whilst the liquid is being heated, use the liquid temperature data to measure the temperature gradient, and estimate the liquid volume based on the temperature gradient. This means that the liquid volume can be estimated using the existing electronic temperature sensor, although an estimation is not possible until heating is taking place and the temperature gradient can be measured.

In some embodiments, in addition or alternatively, the liquid volume estimation means comprises one or more weight sensors (e.g. in the liquid heating vessel or elsewhere in the appliance e.g. in the power base stand of a cordless appliance) configured to measure the weight of the liquid contained within the liquid heating vessel. Using weight sensors to estimate the liquid volume may have the advantage that the liquid volume can be estimated before the liquid has begun to be heated. As such the liquid volume can be estimated more quickly. Further, the use of weight sensors may result in a more accurate estimated liquid volume.

In some embodiments, the appliance comprises a display assembly configured to indicate the current liquid temperature to a user of the appliance. Optionally, the display assembly may also be configured to indicate the estimated liquid volume.

In some embodiments, the liquid heating appliance comprises a power base stand, wherein the liquid heating vessel is a cordless liquid heating vessel arranged to be seated on the power base stand, wherein the power base stand is configured to provide power to the liquid heating vessel (e.g. to the power supply circuit), and wherein the power base stand comprises the processor. This may help to isolate the processor from steam which is generated by the liquid heating vessel.

In some embodiments, the power base stand comprises all control and processing electronics (e.g. processor, display, weight sensor(s)). In some embodiments, the liquid heating appliance comprises a cordless liquid heating vessel arranged to be seated on a power base stand, the electronic temperature sensor being located in the cordless liquid heating vessel and the processor being located in the power base stand. In such embodiments, the liquid temperature data can be transmitted to the processor via a cordless connector set (for example, as described in WO01/28294). The power base stand may further include (the) one or more weight sensors configured to measure the weight of the liquid contained within the cordless liquid heating vessel and to provide weight data to the processor for estimation of the liquid volume. In some embodiments, the power base stand may further include
a/the display assembly configured to indicate to a user of the appliance at least one of: the current liquid temperature and the estimated liquid volume.

It will be appreciated that any aspect described herein may (and preferably does) include one or more (e.g. all) of the optional and preferred features outlined herein. It will be understood that where used herein, the terms such as top, bottom, above, below, base, side, etc. refer to the orientation of the elements which is shown in the Figures.

Certain preferred embodiments of the invention will now be described, by way of example only, with reference to the accompanying drawings, in which:

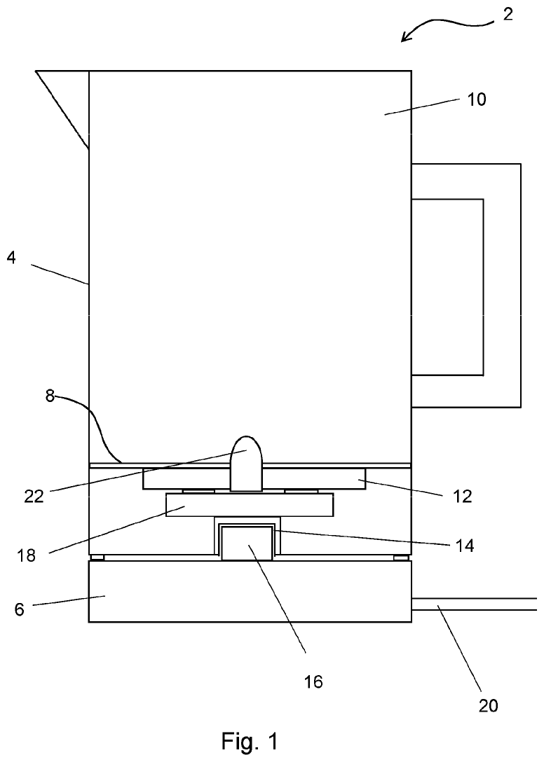

FIG. 1 shows a schematic view of a liquid heating appliance in accordance with a first embodiment of the present invention;

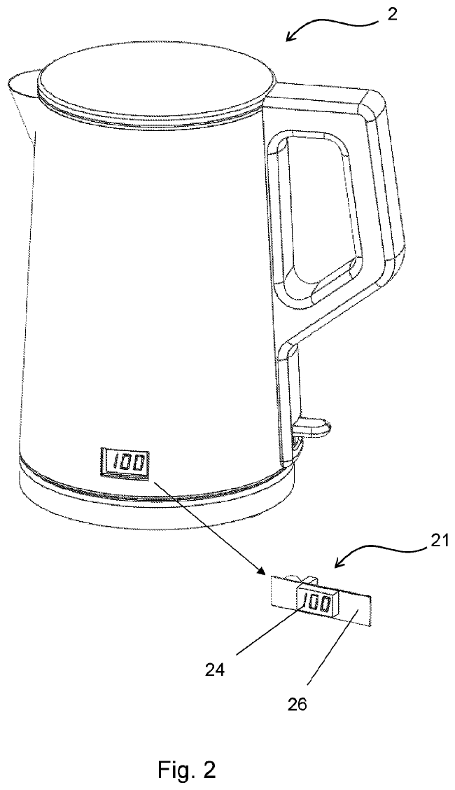

FIG. 2 shows a perspective view of the appliance of FIG. 1;

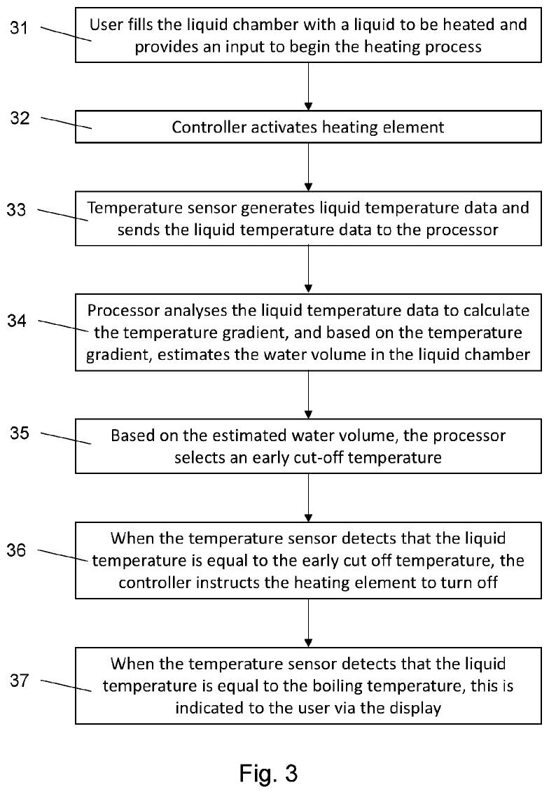

FIG. 3 shows a flow diagram illustrating a method according to an embodiment of the invention;

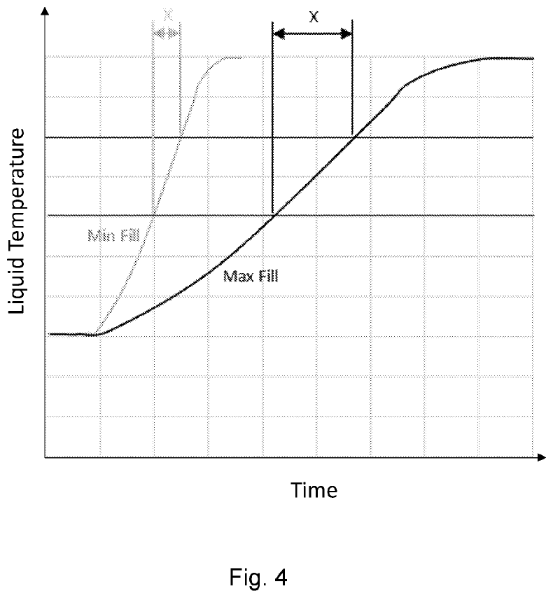

FIG. 4 shows an exemplary graph of liquid temperature plotted against time;

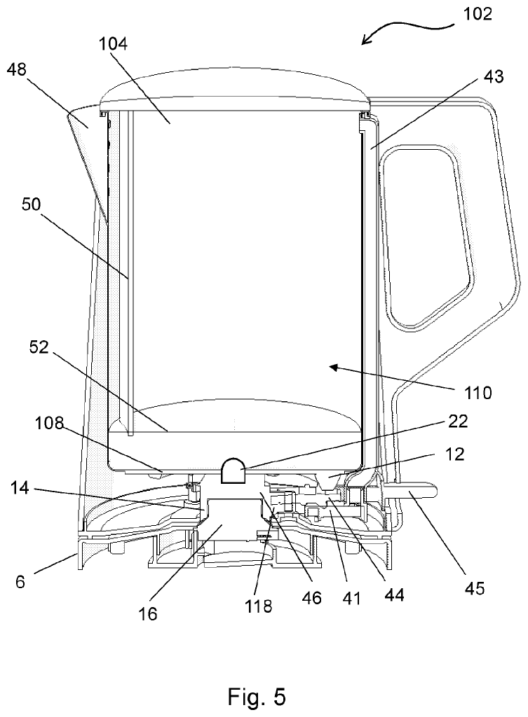

FIG. 5 shows a side view of a liquid heating appliance in accordance with a second embodiment of the present invention;

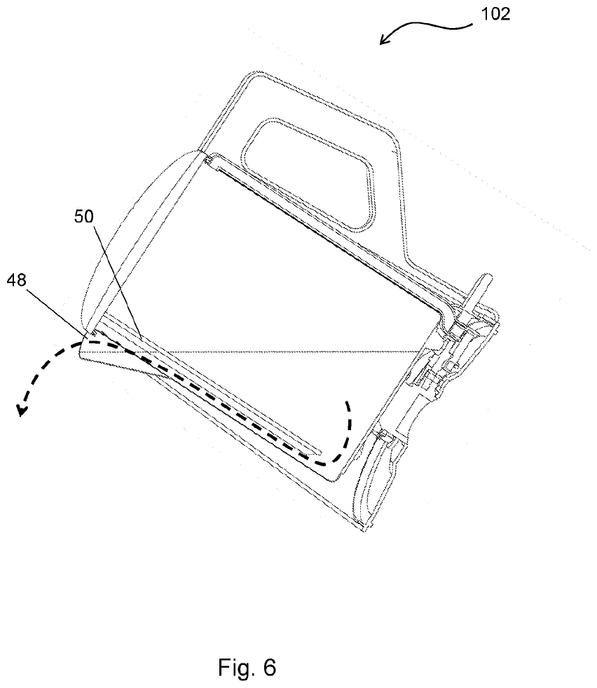

FIG. 6 shows a side view of the liquid heating appliance of FIG. 5 in use;

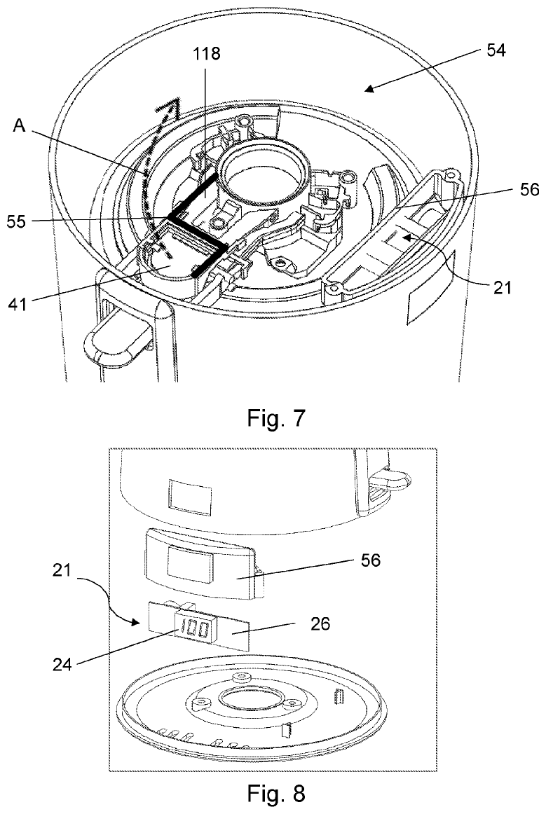

FIG. 7 shows a perspective view of the steam chamber of the liquid heating appliance of FIG. 5;

FIG. 8 shows an exploded view of the display assembly housed in the liquid heating appliance of FIG. 5;

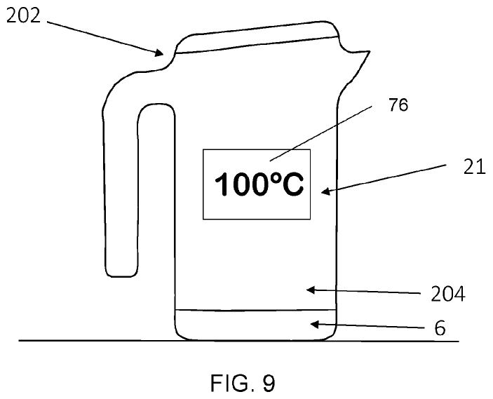

FIG. 9 shows a side view of a liquid heating appliance in accordance with a third embodiment of the present invention; and

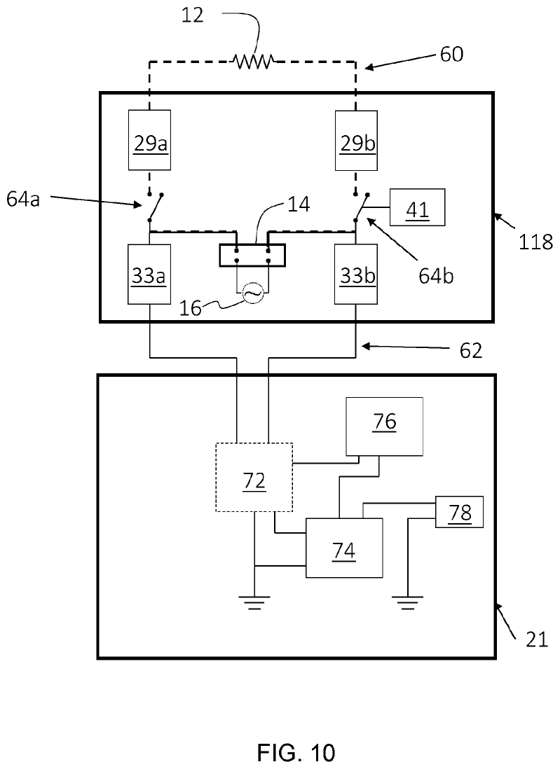

FIG. 10 shows a schematic diagram of the electrical power supply circuits of the liquid heating appliance of FIG. 9;

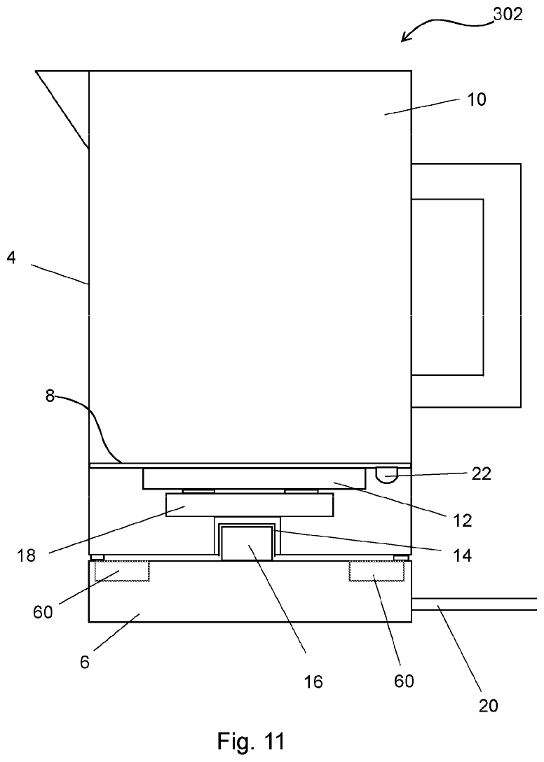

FIG. 11 shows a schematic view of a liquid heating appliance in accordance with a fourth embodiment of the present invention;

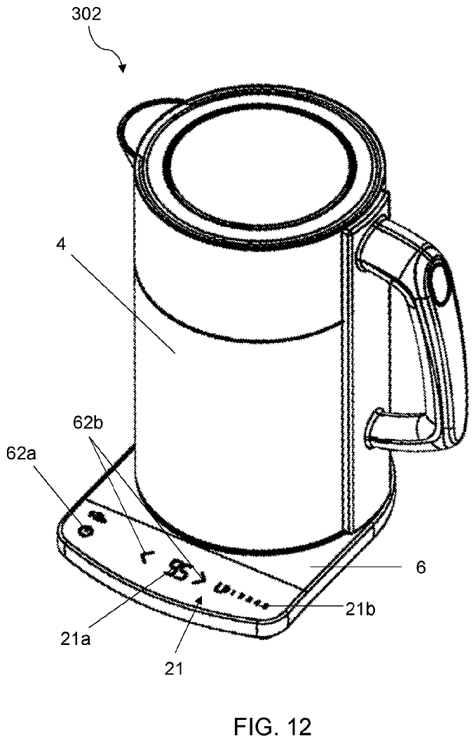

FIG. 12 shows a perspective view of the appliance of FIG. 11;

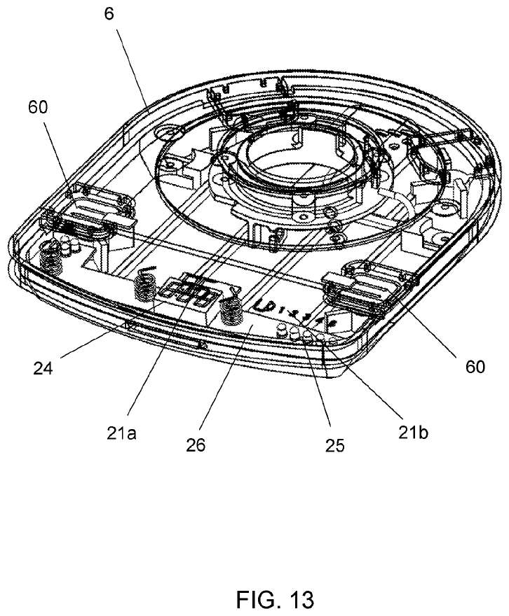

FIG. 13 shows a cut-through view of the power base stand of the liquid heating appliance of FIG. 11;

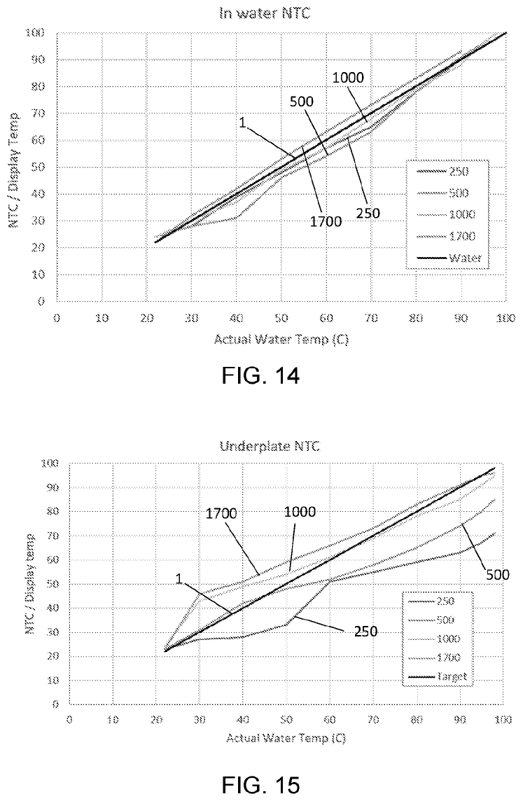

FIGS. 14 and 15 show measured temperature plotted against actual liquid temperature for different sensor placements and liquid volumes;

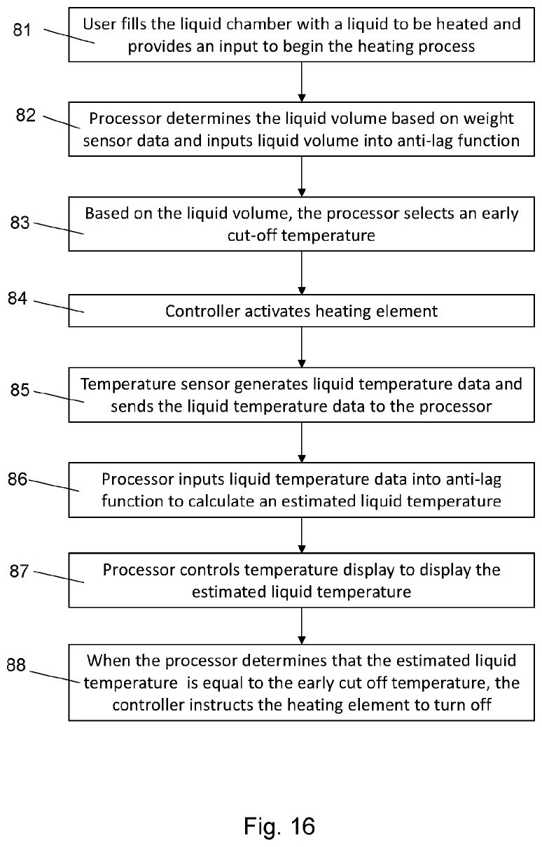

FIG. 16 shows a flow diagram illustrating a method according to an embodiment of the invention.

FIG. 1 shows a schematic view of a liquid heating appliance 2 in accordance with an embodiment of the present invention. In the embodiment depicted, the liquid heating appliance 2 is in the form of a kettle. However, it will be appreciated that the liquid heating appliance 2 may be in any appliance suitable for heating a liquid, e.g. in the form of a milk heating and frothing appliance. The liquid heating appliance 2 comprises a cordless liquid heating vessel 4 and a power base stand 6. The cordless power base stand 6 is shaped to receive the liquid heating vessel 4 thereon. In some embodiments, as depicted, the liquid heating vessel 4 comprises a heated base 8 which defines a liquid chamber 10 which receives a liquid to be heated. The heated base 8 is heated by a heating element 12 and includes a heat diffuser plate.

The liquid heating vessel 4 comprises a cordless electrical adapter part 14 (hereinafter “adapter 14”) arranged to mate with a corresponding base electrical connector part 16 (hereinafter “connector 16”) which is provided on the power base stand 6. The adapter 14 is part of an electrical control unit 18 which controls the supply of electrical power to the heating element 12. The power base stand 6 comprises a power cable 20 which may be plugged into a suitable power source, e.g. a mains electric power supply. The power cable 20 may be suitably electrically connected to the base electrical connector part 16. When the cordless liquid heating vessel 4 is arranged on the power base stand 6, thereby mating the adapter 14 and connector 16, electrical power is able to pass from the power base stand 6 to the liquid heating vessel 4 as is known.

The liquid heating vessel 4 comprises a temperature sensor 22, which in the illustrated embodiment is a thermistor. In the illustrated embodiment, the temperature sensor 22 protrudes through the heated base 8 and into the liquid chamber 10 such that the liquid temperature can be directly measured. In other embodiments, the temperature sensor 22 may not protrude into the liquid chamber 10 and may therefore not directly measure the liquid temperature. For example, the temperature sensor may be mounted beneath and against the heated base 8 and may be configured to measure the temperature of the heated base 8 as being indicative of the liquid temperature. The heating element 12 is shown schematically here and it should be appreciated that the temperature sensor 22 may be mounted so as to avoid contact with the heating element 12 and may even be mounted in a cut-out in the heat diffuser plate so as to be shielded from direct heating by the element 12.

FIG. 2 shows an external view of the liquid heating appliance 2 of FIG. 1. The liquid heating appliance 2 comprises a display assembly 21 comprising a 7-segment display 24 which is controlled by a printed circuit board (PCB) 26 on which the display 24 is mounted. The PCB 26 includes a processor which is configured to receive liquid temperature data from the temperature sensor 22, and to control the display 24 to display the current liquid temperature to a user. In the present embodiment the processor is further connected to the electrical control unit 18 (not shown in FIG. 2) and comprises a controller which is configured to instruct the electrical control unit 18 to control the supply of electrical power to the heating element 12. In other embodiments, the controller for the heating element 12 may be provided by a separate processor.

The operation of the liquid heating appliance 2 will now be explained with reference to the flow chart of FIG. 3.

At step 31, the user fills the liquid chamber 10 with the liquid to be heated and provides an input to begin the heating process. This input may be provided in any suitable and known way, such as via an input button or lever provided on the liquid heating appliance. In response to the user input, at step 32, the controller instructs the electrical control unit 18 to provide electrical power to the heating element 12 in order to activate (e.g. turn on) the heating element 12. The liquid inside the liquid chamber 10 is heated by the heating element 12. Whilst the liquid is being heated, at step 33, the temperature sensor 22 measures the liquid temperature over time and generates a time series of liquid temperature data. This liquid temperature data is sent to the processor for analysis.

At step 34, the processor analyses the time series of liquid temperature data to calculate the temperature gradient. The temperature gradient can be used to estimate the liquid volume in the liquid chamber 10 since a larger volume of liquid will have a shallower temperature gradient. This is illustrated by the graph of FIG. 4. This estimation could be done in any known way. For example, the processor (e.g. a memory of the processor) may be programmed with a plurality of exemplary temperature gradient and liquid volume pairs, and the processor may match the calculated temperature gradient to the closest exemplary temperature gradient, and hence to the paired exemplary liquid volume.

At step 35, based on the estimated liquid volume, the processor selects an early cut-off temperature. This selection could be made in any suitable way, for example, the processor (e.g. a memory of the processor) may be programmed with a plurality of liquid volume and early cut-off temperature pairs. These pairs are known to result in the liquid temperature still reaching boiling point when the heating element 12 is deactivated at the early cut-off temperature. The processor may match the estimated liquid volume to the closest exemplary liquid volume. The paired early cut-off temperature is then selected as the early cut-off temperature. A selection of experimental volume and cut-off temperature pairs are shown below in table 1.

TABLE 1

| Heating | Early cut-off temperature for which the water will still | | |
|---|---|---|---|
| element | reach 100° C. at a water volume of: | | |
| power | 0.5 L | 1.0 L | 1.5 L |
| 3 kW | 96° C. | 98° C. | 98.5° C. |
| 2.2 kW | 96° C. | 98° C. | 98.5° C. |

At step 36, when the temperature sensor 22 detects that the liquid temperature is equal to the early cut off temperature which was selected at step 35, the controller instructs the electrical control unit 18 to cut off the supply of electrical power to the heating element 12 to deactivate (e.g. turn off) the heating element.

As a result of the residual heat of the heating element 12, in particular the heat energy retained in the heated base 8, the liquid temperature will continue to rise even after the heating element 12 has been deactivated. As such, the temperature sensor 22 continues to monitor the liquid temperature, and, at step 37, when the temperature sensor 22 detects that the liquid temperature has reached the boiling temperature, this is indicated to the user via the display 24. In embodiments, this indication may simply be via a light or other visual indication means, or via an audible indication means such as a speaker playing a sound such as a beep to indicate that the liquid has reached its boiling temperature. In the illustrated embodiment however, the current liquid temperature (which is the boiling temperature at step 37) is indicated to the user using the 7-segment display 24.

From Table 1 above it can be appreciated that using the detected temperature gradient to estimate the water volume enables the processor to select an early cut-off temperature that is most appropriate for the volume of liquid present in the liquid chamber 10. If the chamber contains a smaller volume, such as 0.5 L, then the processor can select an earlier cut-off temperature (e.g. 96° C.) and avoid wasting energy heating above this temperature. However, a benefit is still achieved whenever the processor instructs the controller to turn off the heating element at a temperature below boiling point and residual heat is relied upon to bring the liquid temperature up to boiling point.

In another version of this embodiment, steps 34 and 35 are replaced by a single step in which the processor simply compares the liquid temperature data to an early cut-off temperature that is pre-programmed (e.g. stored in a memory). For example, it can be seen from Table 1 that a preset early cut-off temperature of 98.5° C. has been found to allow different volumes of liquid to reach boiling point using the residual heat from a 2.2 KW or 3 KW heating element. In this version of the method, the controller instructs the heating element to turn off when the temperature sensor detects that the liquid temperature is equal to the early cut off temperature without any volume estimation taking place.

FIG. 5 shows a cut-through view of a liquid heating appliance 102 in accordance with a second embodiment of the invention. The liquid heating appliance 102 also comprises a cordless liquid heating vessel 104 and a power base stand 6. The power base stand 6 is shaped to receive the liquid heating vessel 104 thereon. In some embodiments, as depicted, the liquid heating vessel 104 comprises a heated base 108 which defines a liquid chamber 110 which receives a liquid to be heated. The heated base 108 is heated by a sheathed heating element 12 attached to a heat diffuser plate.

The cordless liquid heating vessel 104 comprises a cordless electrical adapter part 14 (hereinafter “adapter 14”) arranged to mate with a corresponding base electrical connector part 16 (hereinafter “connector 16”) which is provided on the power base stand 6. The adapter 14 is part of an electrical control unit 118 which controls the supply of electrical power to the heating element 12. The power base stand 6 comprises a power cable which may be plugged into a suitable power source, e.g. a mains electric power supply. The power cable may be suitably electrically connected to the base electrical connector part 16. When the cordless liquid heating vessel 104 is arranged on the power base stand 6, thereby mating the adapter 14 and connector 16, electrical power is able to pass from the power base stand 6 to the liquid heating vessel 104 as is known.

The cordless electrical control unit 118 comprises a thermomechanical actuator 41, supported by a moulded plastics control body 46. The thermomechanical actuator 41 is a snap-action bimetallic actuator set to operate at a predetermined temperature. In use, when the cordless electrical control unit 118 is mounted within the appliance 102, the thermomechanical actuator 41 is arranged to detect the temperature of steam generated by liquid (e.g. water) boiling within the liquid heating chamber 110 and conveyed via a steam pipe 43 extending from the top of the chamber 110 to the electrical control unit 118, as is known in the art.

The electrical control unit 118 comprises a trip lever 44 that is pivotally mounted on the control body 46. A distal end of the trip lever 44 is arranged to be operated by the thermomechanical actuator 41, while a proximal end of the trip lever 44 is arranged to operate an electrical switch (not shown in FIG. 5) which connects the heating element 12 to the power supply. The trip lever 44 also includes a manual switch extension 45 that protrudes out of the side of the vessel 104 for a user to manually switch on and off the power supply to the heating element 12.

The thermomechanical actuator 41 is arranged such that its operation at the predetermined temperature causes the trip lever 44 to pivot so as to open the electrical switch, thereby disrupting the supply of electrical energy to the heating element 12. This allows the heating element 12 to be switched off when a steam temperature is detected by the thermomechanical actuator 41 that is representative of liquid within the liquid heating vessel 104 approaching boiling.

As discussed in relation to the previously discussed embodiment, the present invention aims to deactivate the heating element 12 at an early cut-off temperature which is lower than the boiling point of the liquid being heated, but sufficiently close to the boiling temperature that the liquid temperature will continue to rise to the boiling temperature after the heating element 12 has been deactivated. In the embodiment of FIG. 5, this objective is achieved by trapping steam inside the chamber 110. Although steam is of course produced when water boils, some steam is produced when the overall liquid temperature is approaching boiling point. In a conventional kettle with a steam pipe 43 and a thermomechanical actuator 41, this small amount of steam is not sufficient to trip the actuator 41 since most of the steam escapes from the spout 48. Therefore, the thermomechanical actuator 41 is not tripped until the water is fully boiling. However, the applicant has realised that by blocking the spout 48, the steam is trapped inside the chamber 110. As such, even before the liquid has reached its boiling point, there is enough steam trapped inside the chamber 110 for a sufficient amount of steam to travel down through the steam pipe 43 and trip the thermomechanical actuator 41. As such, the heating element 12 is deactivated as known in the art, but this deactivation happens at an early cut-off temperature which is below the boiling temperature, saving energy.

The spout 48 is blocked using a baffle 50. In the illustrated embodiment, the baffle 50 is formed as a curved wall (e.g. cylindrical section) which extends from the top of the vessel 104, close to the spout 48, to a point below the minimum fill line 52, and contacts the wall of the vessel 104 on either side of the spout 48 such that a fluid channel is formed which allows liquid which is contained in the chamber 110 to exit the vessel 104 via the spout when the vessel 104 is sufficiently tilted, as shown in FIG. 6. However, since the baffle 50 extends below the minimum fill line 52, steam which rises from the liquid on the side of the baffle distal from the spout 48 cannot escape via the spout 48. As a result of the building pressure inside the chamber 110, the steam is forced into the steam pipe 43 and onto the thermomechanical actuator 41, causing the deactivation of the heating element 12. It will of course be understood that the baffle 50 may take any shape which is suitable for providing the functionality described above.

Although not essential, in the illustrated second embodiment, the liquid heating appliance 102 also comprises a temperature sensor 22 (as shown in FIG. 5), which in the illustrated embodiment is a thermistor. In the illustrated embodiment, the temperature sensor 22 protrudes through the heated base 108 and into the liquid chamber 110 such that the liquid temperature can be directly measured. In other embodiments, the temperature sensor 22 may not protrude into the liquid chamber 110 and may therefore not directly measure the liquid temperature. For example, the temperature sensor may be mounted beneath and against the heated base 108 and may be configured to measure the temperature of the heated base 108 as being indicative of the liquid temperature.

The liquid heating appliance 102 also includes a display assembly 21 comprising a 7-segment display 24 (shown in FIG. 8) which is controlled by a printed circuit board (PCB) 26 on which the display 24 is mounted. The PCB 26 includes a processor which is configured to receive liquid temperature data from temperature sensor 22, and to control the display 24 to display the current liquid temperature to a user.

As seen in FIG. 7, the portion of the liquid heating appliance 102 which houses the thermomechanical actuator 41 is a steam chamber 54 provided at the base of the liquid heating appliance 102. In the illustrated embodiment, due to packaging requirements, and also to minimise wiring, the display assembly 21 is housed inside the steam chamber 54. In order to prevent steam damaging the display assembly 21, a wall 55 is formed between the thermomechanical actuator 41 and the display assembly 21 in order to guide the steam which is incident on the thermomechanical actuator 41 away from the display assembly 21 in the direction of arrow A such that the steam may disperse. This wall 55 can be provided by the electrical control unit 118, for example moulded into the control body as shown, or it can be fitted separately. Further, the display assembly 21 is provided inside a housing 56. This housing 56 further protects the display assembly 21 from direct impingement by steam reaching the steam chamber 54.

In the depicted second embodiment, the electrical control unit 118 is arranged below the heated base 108, which is particularly suitable when it is integrated with a cordless electrical adapter part 14 as shown. However, the electrical control unit 118 could be separate from the cordless electrical adapter part 14 and could be positioned elsewhere in the liquid heating vessel 104, for example along a side wall of the liquid chamber 110 or in the handle. In some other embodiments the liquid heating vessel 104 may not be cordless at all, in which case the electrical control unit 118 may take any suitable position next to the liquid chamber 110 so as to detect the liquid temperature with the temperature sensor 22 and receive power from a mains power supply cord.

In a third embodiment, the display assembly 21 is not housed inside the steam chamber 54. Instead, as shown for the appliance 202 in FIG. 9, the display assembly 21 is positioned in a side wall of the liquid heating vessel 204. This appliance 202 has many features in common with the first and second embodiments, including the cordless liquid heating vessel 204 being seated on a power base stand 6 with a cordless electrical adapter part being arranged to mate with a corresponding base electrical connector part as previously described. The appliance 202 may also use a steam baffling arrangement, as described in relation to the second embodiment, to detect when the liquid contained within the liquid heating vessel is approaching boiling point but has a liquid temperature below its boiling temperature that corresponds to an early cut-off temperature. Thus, an electrical control unit 118 as previously described may be mounted in the base of the vessel 204. However, to provide more freedom for the display assembly 21, the electrical control unit 118 in the third embodiment comprises second set of electrical tabs, connected to the electrical adapter part separately from a first set of electrical tabs that electrically connect to the electrical heater to form a primary electrical power supply circuit. The second set of electrical tabs can electrically connect to the display assembly 21 in a bypass electrical power supply circuit. This is described in more detail with reference to FIG. 10.

FIG. 10 shows a schematic diagram of the electrical power supply circuits of the appliance 202 of FIG. 9. The appliance 202 comprises a primary electrical power circuit 60 (represented by dashed lines in FIG. 10) and an auxiliary electrical power circuit 62 (represented by solid lines).

As discussed above, the control unit 118 of the appliance 202 comprises a cordless electrical adapter part 14 that can connect to a corresponding base electrical connector part 16, which supplies AC current to the electrical components of the vessel 204 when the vessel 204 is positioned on the power base stand 6. The control unit 118 further comprises a pair of switches 64a, 64b and a first pair of fixed electrical tabs 29a, 29b. Each tab 29a, 29b is connected to the cordless electrical adapter part 14 via a respective one of the switches 64a, 64b.

The electrical heating element 12 is connected across the first pair of tabs 29a, 29b, thereby completing the primary electrical power circuit 60. The thermomechanical actuator 41 is arranged to open the switches 64a, 64b when the predetermined temperature is sensed. This causes the electrical heating element 12 to be disconnected from the electrical power supply provided by the base electrical connector part 16, thereby turning off the heater 12.

The control unit 118 further comprises a second pair of fixed electrical tabs 33a, 33b, each connected to the cordless electrical adapter part 14. Unlike the first pair of fixed electrical tabs 29a, 29b, each of the second pair of fixed electrical tabs 33a, 33b is connected directly to the cordless electrical adapter part 14, rather than via a switch.

A display assembly 21 is connected across the second pair of fixed electrical tabs 33a, 33b, thereby completing the auxiliary electrical power circuit 62, which is in parallel with the primary electrical power circuit 60.

Owing to the arrangement described above, when the thermomechanical actuator 41 operates to open the switches 64a, 64b so as to disconnect the electrical heating element 12 from the power source provided by the base electrical connector part 16, the supply of electrical power to the auxiliary electrical power circuit 62 is not disrupted.

In this example, the display assembly 21 optionally comprises a rechargeable power source 72 that is directly connected to the second pair of fixed electrical tabs 33a, 33b. The rechargeable power source 72 is arranged to store electrical energy received from the power supply of the base electrical connector part 16 when the vessel 204 is arranged on the power base stand 6. This means that, after the vessel 204 has been lifted away from the power base stand 6, such that the cordless electrical adapter part 14 and the base electrical connector part 16 are no longer connected, the rechargeable power source 72 can provide electrical power to the other components of the display assembly 21. Therefore, the display assembly 21 can continue to operate even after the vessel 204 has been removed from the power base stand 6.

The display assembly 21 comprises a processor 74, an electronic alphanumeric display 76, and a thermistor 78 acting as the liquid temperature sensor, each of which is arranged to receive electrical power from the rechargeable power source 72. The thermistor 78 may pass through a side wall of the liquid heating chamber to directly contact liquid contained therein.

As seen in FIG. 9, the electronic alphanumeric display 76 is visible on the side of the liquid heating vessel 204. The auxiliary electrical power circuit 62 ensures that the display 76 can indicate to a user that the liquid temperature continues to rise and has reached the boiling temperature after the thermomechanical actuator 41 has operated to interrupt the primary electrical power circuit 60. If the rechargeable power source 72 is included in the display assembly 21, then the display 76 can continue to indicate the liquid temperature even after the vessel 204 has been removed from the power base stand 6.

FIG. 11 shows a schematic view of a cordless liquid heating appliance 302 in accordance with a fourth embodiment of the present invention. FIG. 12 shows perspective view of the liquid heating appliance 302. The liquid heating appliance 302 shown in FIGS. 11 and 12 is a variant of the liquid heating appliance 2 shown in FIGS. 1 and 2. In the embodiment depicted, the liquid heating appliance 302 is in the form of a kettle. However, it will be appreciated that the liquid heating appliance 302 may be any appliance suitable for heating a liquid, e.g. in the form of a milk heating and frothing appliance. The liquid heating appliance 302 comprises a cordless liquid heating vessel 4 and a power base stand 6. The cordless power base stand 6 is shaped to receive the liquid heating vessel 4 thereon. In some embodiments, as depicted, the liquid heating vessel 4 comprises a heated base 8 which defines a liquid chamber 10 which receives a liquid to be heated. The heated base 8 is heated by a heating element 12 and includes a heat diffuser plate.

The liquid heating vessel 4 comprises a cordless electrical adapter part 14 (hereinafter “adapter 14”) arranged to mate with a corresponding base electrical connector part 16 (hereinafter “connector 16”) which is provided on the power base stand 6. The adapter 14 is part of an electrical control unit 18 which controls the supply of electrical power to the heating element 12. The power base stand 6 comprises a power cable 20 which may be plugged into a suitable power source, e.g. a mains electric power supply. The power cable 20 may be suitably electrically connected to the base electrical connector part 16. When the cordless liquid heating vessel 4 is arranged on the power base stand 6, thereby mating the adapter 14 and connector 16, electrical power is able to pass from the power base stand 6 to the liquid heating vessel 4 as is known.

The liquid heating vessel 4 comprises a temperature sensor 22, which in the illustrated embodiment is a thermistor (e.g. NTC thermistor). The temperature sensor 22 is mounted beneath and against the heated base 8 and is configured to measure the temperature of the heated base 8 as being indicative of the liquid temperature. The heating element 12 is shown schematically here and it should be appreciated that the temperature sensor 22 may be mounted so as to avoid contact with the heating element 12 and may even be mounted in a cut-out in the heat diffuser plate so as to be shielded from direct heating by the element 12. In other embodiments (such as that shown in FIGS. 1 and 2), the temperature sensor 22 may protrude through the heated base 8 and into the liquid chamber 10 such that the liquid temperature can be directly measured.

The power base stand 6 comprises a pair of weight sensors 60 which are configured to measure the weight of the liquid heating vessel 4.

FIG. 12 shows an external view of the liquid heating appliance 302 of FIG. 11. The liquid heating appliance 302 comprises a display assembly 21 provided on the power base stand 6. The display assembly 21 comprises a temperature display 21a, and a fill level display 21b. In the illustrated embodiment, the fill level display 21b is configured to display the number of cups of liquid which are present inside the liquid heating vessel by illuminating cup icons. In other embodiments, the fill level display may display the volume of liquid inside the liquid heating vessel 4 in other units (e.g. millilitres, fluid ounces, etc.) The power base stand 6 further comprises a plurality of user input elements 62, a power on/off input element 62a, and a temperature adjustment input element 62b. A user can select a temperature of 100° C. when it is desired to heat liquid to boiling.

FIG. 13 shows a cut-through perspective view of the power base stand 6 of the liquid heating appliance 302. The weight sensors 60 can be seen in FIG. 13.

It is also shown in FIG. 13 that the temperature display 21a comprises a 7-segment display 24, and that the fill level display 21b comprises a plurality of LEDs 25. The 7-segment display 24 and the LEDs 25 are controlled by a printed circuit board (PCB) 26 on which they are mounted. The PCB 26 includes a processor (not shown) which is configured to receive liquid temperature data transmitted via the adapter 14 and connector 16 from the temperature sensor 22, and liquid heating vessel weight data from the weight sensors 60. The adapter 14 and connector 16 may be a 5-pole connector set of the “P76” type available from Strix. Based on this data, the processor is configured to control the temperature display 21a to display the current liquid temperature to a user, and to control the fill level display 21b to display the current fill level to a user.

In embodiments, the processor may be configured to calculate an estimated liquid temperature based on the liquid temperature data from the temperature sensor 22, and to control the temperature display 21a to display the estimated liquid temperature to a user. This is discussed in greater detail below with reference to FIGS. 13-15. In the present embodiment the processor is further connected to the electrical control unit 18 (not shown in FIG. 13) and comprises a controller which is configured to instruct the electrical control unit 18 to control the supply of electrical power to the heating element 12. In other embodiments, the controller for the heating element 12 may be provided by a separate processor. It can thus be seen that, other than the temperature sensor 22, all the control and processing electronics are in the power base stand 6.

In the liquid heating appliance 302, the temperature sensor 22 is not in direct contact with the liquid, but rather is mounted below the heated base 8. This arrangement may be advantageous for simplifying construction of the liquid heating appliance 302. However, since the temperature sensor 22 is not able to directly measure the liquid temperature, this arrangement may lead to a time lag between changes in the measured temperature, and changes in the actual liquid temperature. This issue is exemplified by the plots of FIGS. 14 and 15. FIG. 14 shows the temperature measured by a temperature sensor (“NTC”) in direct contact with water being heated plotted against the actual water temperature for different water volumes. Line 1 shows the target, where the measured temperature corresponds to the actual water temperature. Lines 250, 500, 1000, and 1700 each represent the data gathered when the volume of water in the liquid heating vessel 4 was 250 ml, 500 ml, 1000 ml, and 1700 ml respectively. It can be seen from FIG. 14 that for each of the different volumes, the lines are close to the target line, and so the measured temperature is tracking reliably with the actual temperature.

FIG. 15 shows the temperature measured by a temperature sensor (“NTC”) mounted below the heated base 8 plotted against the actual water temperature for different water volumes. Line 1 shows the target, where the measured temperature corresponds to the actual water temperature. Lines 250, 500, 1000, and 1700 each represent the data gathered when the volume of water in the liquid heating vessel 4 was 250 ml, 500 ml, 1000 ml, and 1700 ml respectively. It can be seen from FIG. 15 that, for each of the different volumes, the lines are further from the target line 1 when compared with the plot of FIG. 14. For higher liquid volumes (see lines 1000, and 1700) the measured temperature is initially much higher (up to 15 degrees higher) than the actual temperature. This is because the large volume of liquid takes longer to heat up and so, early on in the heating cycle, the temperature of the heated base 8 is much higher than the temperature of the liquid. As time goes on, the liquid temperature aligns with the temperature of the base 8 which is why the lines 1000, 1700 are much closer to the target line 1 later on in the heating cycle.

By contrast, for lower liquid volumes, the liquid heats up more quickly (i.e. before the heated plate 8 has reached equilibrium). As such, it can be seen for line 250 in particular that the measured temperature lags behind the actual temperature for the entire heating cycle. When the liquid volume is 250 ml, it can be seen from FIG. 15 that the measured temperature is only 70 degrees when the water is in fact almost boiling. This can lead to overboil which results in wasted energy. This can be combatted by imposing a minimum fill requirement, but this again results in wasted energy in the situation where a user only wishes to heat a small amount of water, but must heat more to reduce the overboil risk.

Since the relationship between the measured temperature and the actual temperature is dependent on the volume of liquid being heated, an anti-lag function can be developed (e.g. based on experimental data) having liquid volume as a variable. As such, if the volume of liquid in the liquid heating vessel 8 is known, the anti-lag function can be used to compensate for the time lag, reducing the risk of overboil.

The operation of the liquid heating appliance 302 shown in FIGS. 11 to 13 will now be explained with reference to the flow chart of FIG. 16.

At step 81, the user fills the liquid chamber 10 with the liquid to be heated and provides an input to begin the heating process. This input may be provided in any suitable and known way. In the illustrated embodiment, the input may comprise selecting a target temperature (e.g. boiling) using the temperature adjustment input element 62b, and then starting the heating cycle using the power on/off input element 62a.

At step 82, the liquid volume present in the liquid chamber 10 is determined using the weight sensors 60. The processor is pre-programmed with an anti-lag function configured to take liquid volume as a variable. As such, based on this determination, the liquid volume is input into the anti-lag function. In embodiments, the weight sensors 60 may be omitted from the liquid heating appliance 302, and the liquid volume may be estimated based on the temperature gradient as explained in relation to steps 32, 33, and 34 of the method illustrated in FIG. 3.

At step 83, based on the determined liquid volume, the processor selects an early cut-off temperature. This selection could be made in any suitable way, for example, the processor (e.g. a memory of the processor) may be programmed with a plurality of liquid volume and early cut-off temperature pairs. These pairs are known to result in the liquid temperature still reaching boiling point when the heating element 12 is deactivated at the early cut-off temperature. The processor may match the estimated liquid volume to the closest exemplary liquid volume. The paired early cut-off temperature is then selected as the early cut-off temperature. A selection of experimental volume and cut-off temperature pairs are shown above in table 1.

In response to the user input, at step 84, the controller instructs the electrical control unit 18 to provide electrical power to the heating element 12 in order to activate (e.g. turn on) the heating element 12. The liquid inside the liquid chamber 10 is heated by the heating element 12.

Whilst the liquid is being heated, at step 85, the temperature sensor generates liquid temperature data and sends this data to the processor. At step 86, the processor inputs the liquid temperature data into the anti-lag function to calculate the current estimated liquid temperature. At step 87, the processor controls the temperature display 21a to display the current estimated liquid temperature.

At step 88, when the temperature sensor 22 detects that the liquid temperature is equal to the early cut off temperature which was selected at step 83, the controller instructs the electrical control unit 18 to cut off the supply of electrical power to the heating element 12 to deactivate (e.g. turn off) the heating element.

As a result of the residual heat of the heating element 12, in particular the heat energy retained in the heated base 8, the liquid temperature will continue to rise even after the heating element 12 has been deactivated. As such, the temperature sensor 22 continues to monitor the liquid temperature, and the processor continues to calculate the estimated liquid temperature using the anti-lag function, and, at step 37, when the estimated liquid temperature has reached the target temperature (e.g. boiling temperature), this is indicated to the user via the display 21a. In embodiments, this indication may simply be via a light or other visual indication means, or via an audible indication means such as a speaker playing a sound such as a beep to indicate that the liquid has reached its boiling temperature.

From Table 1 above it can be appreciated that using the detected temperature gradient to estimate the water volume enables the processor to select an early cut-off temperature that is most appropriate for the volume of liquid present in the liquid chamber 10. If the chamber contains a smaller volume, such as 0.5 L, then the processor can select an earlier cut-off temperature (e.g. 96° C.) and avoid wasting energy heating above this temperature. However, a benefit is still achieved whenever the processor instructs the controller to turn off the heating element at a temperature below boiling point and residual heat is relied upon to bring the liquid temperature up to boiling point.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A liquid heating appliance for heating liquid to a boiling temperature, comprising:
a liquid heating vessel;
an electrical heater for heating liquid contained within the liquid heating vessel, and an electrical power supply circuit arranged to power the electrical heater;
detection means arranged to detect when the liquid contained within the liquid heating vessel is approaching boiling point but has a liquid temperature below its boiling temperature that corresponds to an early cut-off temperature; and
an electrical control unit comprising control circuitry arranged to interrupt the electrical power supply circuit, thereby deactivating the electrical heater, in response to the detection means detecting that the liquid temperature corresponds to the early cut-off temperature,
wherein the liquid heating vessel is configured such that residual heat of the electrical heater causes the liquid temperature to continue to rise to the boiling temperature after the electrical heater has been deactivated at the early cut-off temperature.

2. The liquid heating appliance of claim 1, wherein the appliance comprises a processor and an electronic temperature sensor configured to provide liquid temperature data to the processor, and further comprising a display assembly configured to indicate to a user of the appliance that the liquid temperature has reached the boiling temperature when it is determined by the processor, based on the liquid temperature data, that the liquid has reached the boiling temperature due to the residual heat.

3. The liquid heating appliance of claim 2, wherein the display assembly is configured to display a liquid temperature value based on the liquid temperature data provided by the electronic temperature sensor.

4. (canceled)

5. The liquid heating appliance of claim 2, comprising a power base stand and wherein the liquid heating vessel is a cordless liquid heating vessel arranged to be seated on the power base stand, wherein the power base stand is configured to provide power to the liquid heating vessel, and wherein the power base stand comprises the display assembly.

6. (canceled)

7. The liquid heating appliance of claim 1, wherein the detection means comprises the/an electronic temperature sensor arranged to detect that liquid within the liquid heating vessel has reached the early cut-off temperature.

8. The liquid heating appliance of claim 1, comprising liquid volume estimation means configured to estimate a volume of the liquid contained within the liquid heating vessel.

9. The liquid heating appliance of claim 8, wherein the liquid volume estimation means comprises a/the processor configured to:
obtain liquid temperature data from the/an electronic temperature sensor whilst the liquid is being heated,
use the liquid temperature data to measure the temperature gradient, and estimate the liquid volume based on the temperature gradient.

10. The liquid heating appliance of claim 8, wherein the liquid volume estimation means comprise one or more weight sensors configured to measure the weight of the liquid contained within the liquid heating vessel.

11. The liquid heating appliance of claim 8, wherein the liquid heating appliance comprises a/the processor configured to set the early cut-off temperature based on the estimated liquid volume.

12. The liquid heating appliance of claim 8, comprising a/the processor programmed with an anti-lag function which is dependent on liquid volume, and is configured to account for time lag between liquid temperature data and the (e.g. actual) liquid temperature, wherein the processor is configured to estimate the current liquid temperature based on liquid temperature data, the anti-lag function, and the estimated liquid volume.

13-23. (canceled)

24. A method of heating liquid contained within a liquid heating vessel to a boiling temperature, comprising:
activating an electrical heater by completing an electrical power supply circuit to the electrical heater;
detecting when the liquid contained within the liquid heating vessel is approaching boiling point but has a liquid temperature below its boiling temperature that corresponds to an early cut-off temperature; and
interrupting the electrical power supply circuit, thereby deactivating the electrical heater, in response to detecting that the liquid temperature corresponds to the early cut-off temperature, such that residual heat of the electrical heater causes the liquid temperature to continue to rise to the boiling temperature after the electrical heater has been deactivated at the early cut-off temperature.

25. (canceled)

26. The method of claim 24, comprising obtaining liquid temperature data using an electronic temperature sensor and displaying to a user a liquid temperature value based on the obtained liquid temperature data.

27. The method of claim 24, further comprising:
measuring or estimating a volume of the liquid contained within the liquid heating vessel.

28. The method of claim 27, wherein the method further comprises setting the early cut-off temperature based on the measured or estimated liquid volume.

29. The method of claim 27, wherein the method further comprises:
using an anti-lag function which is dependent on liquid volume, and is configured to account for time lag between liquid temperature data and the liquid temperature, to estimate the current liquid temperature based on liquid temperature data, the anti-lag function, and the measured or estimated liquid volume.

30. A liquid heating appliance for heating liquid to a target temperature, comprising:
a liquid heating vessel;
an electrical heater for heating liquid contained within the liquid heating vessel, and an electrical power supply circuit arranged to power the electrical heater;
a processor;
an electronic temperature sensor configured to provide, to the processor, liquid temperature data for liquid contained within the liquid heating vessel; and
liquid volume estimation means configured to estimate a liquid volume contained within the liquid heating vessel,
wherein the processor is programmed with an anti-lag function, the anti-lag function being dependent on the liquid volume and configured to account for time lag between the liquid temperature data and the (e.g. actual) temperature of liquid contained within the liquid heating vessel, wherein the processor is configured to estimate a current liquid temperature based on the liquid temperature data, the anti-lag function, and the estimated liquid volume.

31. The liquid heating appliance of claim 30, wherein the liquid volume estimation means comprises a/the processor, and wherein the processer is configured to:
obtain liquid temperature data from the electronic temperature sensor whilst the liquid is being heated,
use the liquid temperature data to measure the temperature gradient, and estimate the liquid volume based on the temperature gradient.

32. The liquid heating appliance of claim 30, wherein the liquid volume estimation means comprise one or more weight sensors configured to measure the weight of the liquid contained within the liquid heating vessel.

33. The liquid heating appliance of claim 30, comprising a power base stand and wherein the liquid heating vessel is a cordless liquid heating vessel arranged to be seated on the power base stand, wherein the power base stand is configured to provide power to the liquid heating vessel, and wherein the power base stand comprises the processor.

34. The liquid heating appliance of claim 33, wherein the power base stand further includes one or more weight sensors configured to measure the weight of the liquid contained within the cordless liquid heating vessel and to provide weight data to the processor for estimation of the liquid volume.

35. (canceled)
